(19) United States
(12) Patent Application Publication
(10) Pub. No.: US 2018/0356559 A1
(43) Pub. Date: Dec. 13, 2018

(54) TRACKING SYSTEM FOR PLASTIC PIPE

(71) Applicant: A.I. INNOVATIONS N.V., Corte Madera, CA (US)

(72) Inventor: Rodney Ruskin, San Rafael, CA (US)

(21) Appl. No.: 16/003,923

(22) Filed: Jun. 8, 2018

Related U.S. Application Data
(60) Provisional application No. 62/517,839, filed on Jun. 9, 2017.

(51) Int. Cl. G01V 15/00; G01S 13/88; G01V 3/12; F16L 9/127; B29C 47/00

(52) U.S. Cl. CPC G01V 15/00; G01S 13/885; G01V 3/12; B29K 2101/12; B29C 47/0023; B29K 2995/0005; B29K 2995/0008; F16L 9/127

(57) ABSTRACT

There is provided a plastic cylindrical pipe including a nonconductive wall, wherein the wall includes a filler that is either electrically conductive or magnetic.

### CROSS-REFERENCE TO RELATED APPLICATION(S)

This application claims priority to, and the benefit of, U.S. Provisional Application Ser. No. 62/517,839, filed on Jun. 9, 2017, entitled Tracking System For Buried Plastic Pipe, the entire content of which is incorporated herein by reference.

### BACKGROUND

### 1. Field

One or more aspects of embodiments disclosed herein relate to a trackable and locatable pipe.

### 2. Description of Related Art

Pipes may be used in a variety of locations where the pipes may not be readily visible. For example, drip irrigation is a form of irrigation that may enable soil to store water and nutrients by allowing water to drip slowly from a plastic dripline near roots of plants and trees. The dripline may be buried below the surface of the ground. Accordingly, the dripline enables water to be delivered near or directly into a root zone of an intended plant, tree, or cactus with little or minimal evaporation prior to being absorbed by the root system of nearby foliage. Drip irrigation systems may distribute water through a network of valves, pipes, tubing, and emitters, and may be more efficient than other types of irrigation systems (e.g., more efficient than surface irrigation or sprinkler systems).

### SUMMARY

Aspects of embodiments of the present disclosure are directed toward an improved plastic pipe capable of being placed underground and subsequently located and tracked, to a method of manufacturing the plastic pipe, and a method for tracking and locating the plastic pipe.

According to an embodiment of the present disclosure, there is provided a plastic cylindrical pipe including a nonconductive wall, wherein the wall includes a filler that is either electrically conductive or magnetic.

The filler may include a carbon-based material.

The carbon-based material may include a high structure carbon black material.

The high structure carbon black material may include graphite, graphene, or carbon nanomaterial.

The filler may be configured to receive and emit a signal detectable by a sensor.

The filler may be magnetic and may include discontinuous sections that are about one inch in length and that are separated by up to a foot.

The filler may include iron.

The filler may include iron oxide having the chemical formula of Fe3O4.

The pipe may further include a coating covering the filler, the coating being reflective to radio waves.

The filler may be reflective of radio waves.

The filler may be arranged along a length of the pipe.

The filler may include a stripe extending along the length of the pipe.

The filler may include a plurality of separate stripes at different sides on an outside of the wall of the pipe and extending along the length of the pipe.

The pipe may include a subsurface drip irrigation tube.

The wall may define a plurality of openings.

According to another embodiment of the present disclosure, there is provided a method of forming a plastic cylindrical pipe including a nonconductive wall, wherein the wall includes a filler that is either electrically conductive or magnetic, the method including adding material for the pipe to an extruder, melting the material for the pipe, pushing the melted material for the pipe through a die over a mandrel, adding material for the filler into another extruder, melting the added material for the filler, and pushing the melted material for the filler through the die.

The filler may include a stripe extending along a length of the pipe, the method further including adding the melted added material for the filler to the melted material for the pipe prior to cooling the melted material for the pipe.

According to yet another embodiment of the present disclosure, there is provided a method of locating a plastic cylindrical pipe including a nonconductive wall, wherein the wall includes a filler that is either electrically conductive or magnetic, the method including receiving, by a portion of the filler, a signal emitted from a transmitter, transmitting, by the portion of the filler, the signal to another portion of the filler, emitting, by the other portion of the filler, another signal, detecting the signal using a sensor, and estimating a location of the plastic cylindrical pipe based on the detected signal.

The sensor may include a ground-penetrating radar system.

The sensor may be mounted on a piece of farming equipment.

Accordingly, the device/plastic pipe according to embodiments of the present disclosure are able to provide an improved plastic pipe including an electrically conductive and/or magnetic element, which enables an improved method of locating and tracking the pipe when it is placed underground.

### BRIEF DESCRIPTION OF THE DRAWINGS

Some embodiments can be understood in more detail from the following description taken in conjunction with the accompanying drawings, in which:

FIG. 1 is a perspective view of a section of plastic pipe according to an embodiment of the present disclosure;

FIG. 2 is a front view of the section of plastic pipe of FIG. 1;

FIG. 3 is a top view of the section of plastic pipe of FIG. 1;

FIG. 4 is a flowchart of a method of locating and tracking a plastic pipe located underground and including a filler, according to an embodiment of the present disclosure; and

FIG. 5 is a flowchart of a method of manufacturing a plastic pipe including a filler, according to an embodiment of the present disclosure.

### DETAILED DESCRIPTION

Features of the inventive concept and methods of accomplishing the same may be understood more readily by reference to the following detailed description of embodiments and the accompanying drawings. Hereinafter, embodiments will be described in more detail with reference to the accompanying drawings. The present invention, however, may be embodied in various different forms, and should not be construed as being limited to only the illustrated embodiments herein. Rather, these embodiments are provided as examples so that this disclosure will be thorough and complete, and will fully convey the aspects and features of the present invention to those skilled in the art. Accordingly, processes, elements, and techniques that are not necessary to those having ordinary skill in the art for a complete understanding of the aspects and features of the present invention may not be described. Unless otherwise noted, like reference numerals denote like elements throughout the attached drawings and the written description, and thus, descriptions thereof will not be repeated. Further, parts not related to the description of the embodiments might not be shown to make the description clear. In the drawings, the relative sizes of elements, layers, and regions may be exaggerated for clarity.

In the following description, for the purposes of explanation, numerous specific details are set forth to provide a thorough understanding of various embodiments. It is apparent, however, that various embodiments may be practiced without these specific details or with one or more equivalent arrangements.

Spatially relative terms, such as “beneath,” “below,” “lower,” “under,” “above,” “upper,” and the like, may be used herein for ease of explanation to describe one element or feature's relationship to another element(s) or feature(s) as illustrated in the figures. It will be understood that the spatially relative terms are intended to encompass different orientations of the device in use or in operation, in addition to the orientation depicted in the figures. For example, if the device in the figures is turned over, elements described as “below” or “beneath” or “under” other elements or features would then be oriented “above” the other elements or features. Thus, the example terms “below” and “under” can encompass both an orientation of above and below. The device may be otherwise oriented (e.g., rotated 90 degrees or at other orientations) and the spatially relative descriptors used herein should be interpreted accordingly. Similarly, when a first part is described as being arranged “on” a second part, this indicates that the first part is arranged at an upper side or a lower side of the second part without the limitation to the upper side thereof on the basis of the gravity direction.

It will be understood that when an element, layer, region, or component is referred to as being “on,” “connected to,” or “coupled to” another element, layer, region, or component, it can be directly on, connected to, or coupled to the other element, layer, region, or component, or one or more intervening elements, layers, regions, or components may be present. However, “directly connected/directly coupled” refers to one component directly connecting or coupling another component without an intermediate component. Meanwhile, other expressions describing relationships between components such as “between,” “immediately between” or “adjacent to” and “directly adjacent to” may be construed similarly. In addition, it will also be understood that when an element or layer is referred to as being “between” two elements or layers, it can be the only element or layer between the two elements or layers, or one or more intervening elements or layers may also be present.

The terminology used herein is for the purpose of describing particular embodiments only and is not intended to be limiting of the present invention. As used herein, the singular forms “a” and “an” are intended to include the plural forms as well, unless the context clearly indicates otherwise. It will be further understood that the terms “comprises,” “comprising,” “have,” “having,” “includes,” and “including,” when used in this specification, specify the presence of the stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

As used herein, the term “substantially,” “about,” “approximately,” and similar terms are used as terms of approximation and not as terms of degree, and are intended to account for the inherent deviations in measured or calculated values that would be recognized by those of ordinary skill in the art. “About” or “approximately,” as used herein, is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” may mean within one or more standard deviations, or within ±30%, 20%, 10%, 5% of the stated value. Further, the use of “may” when describing embodiments of the present disclosure refers to “one or more embodiments of the present disclosure.” As used herein, the terms “use,” “using,” and “used” may be considered synonymous with the terms “utilize,” “utilizing,” and “utilized,” respectively. Also, the term “exemplary” is intended to refer to an example or illustration.

When a certain embodiment may be implemented differently, a specific process order may be performed differently from the described order. For example, two consecutively described processes may be performed substantially at the same time or performed in an order opposite to the described order.

Also, any numerical range disclosed and/or recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such subranges would comply with the requirements of 35 U.S.C. § 112(a) and 35 U.S.C. § 132(a).

Various embodiments are described herein with reference to sectional illustrations that are schematic illustrations of embodiments and/or intermediate structures. As such, variations from the shapes of the illustrations as a result, for example, of manufacturing techniques and/or tolerances, are to be expected. Further, specific structural or functional descriptions disclosed herein are merely illustrative for the purpose of describing embodiments according to the concept of the present disclosure. Thus, embodiments disclosed herein should not be construed as limited to the particular illustrated shapes of regions, but are to include deviations in shapes that result from, for instance, manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the drawings are schematic in nature and their shapes are not intended to illustrate the actual shape of a region of a device and are not intended to be limiting. Additionally, as those skilled in the art would realize, the described embodiments may be modified in various different ways, all without departing from the spirit or scope of the present disclosure.

The electronic or electric devices and/or any other relevant devices or components according to embodiments of the present invention described herein may be implemented utilizing any suitable hardware, firmware (e.g. an application-specific integrated circuit), software, or a combination of software, firmware, and hardware. For example, the various components of these devices may be formed on one integrated circuit (IC) chip or on separate IC chips. Further, the various components of these devices may be implemented on a flexible printed circuit film, a tape carrier package (TCP), a printed circuit board (PCB), or formed on one substrate. Further, the various components of these devices may be a process or thread, running on one or more processors, in one or more computing devices, executing computer program instructions and interacting with other system components for performing the various functionalities described herein. The computer program instructions are stored in a memory which may be implemented in a computing device using a standard memory device, such as, for example, a random access memory (RAM). The computer program instructions may also be stored in other non-transitory computer readable media such as, for example, a CD-ROM, flash drive, or the like. Also, a person of skill in the art should recognize that the functionality of various computing devices may be combined or integrated into a single computing device, or the functionality of a particular computing device may be distributed across one or more other computing devices without departing from the spirit and scope of the exemplary embodiments of the present invention.

Unless otherwise defined, all terms (including technical and scientific terms) used herein have the same meaning as commonly understood by one of ordinary skill in the art to which the present invention belongs. It will be further understood that terms, such as those defined in commonly used dictionaries, should be interpreted as having a meaning that is consistent with their meaning in the context of the relevant art and/or the present specification, and should not be interpreted in an idealized or overly formal sense, unless expressly so defined herein.

Embodiments of the present disclosure are described below.

Driplines may be formed by extruding plastic pipe. To be detectable after being buried underground, a conductive wire or electric cable may be placed alongside the plastic pipe. For example, there may be buried a conductive wire in the same trench in which the plastic pipe is placed before burying the plastic pipe. This enables the use of sensors to detect the area in which the plastic pipe is located. Accordingly, such areas can be avoided when using heavy machinery or agricultural/farming equipment, thereby avoiding unintentionally damaging the plastic pipe that is hidden from view. However, including the conductive wire may significantly add to the cost of burying the plastic pipe in both materials and labor, and the wire may become separated from the pipe over time.

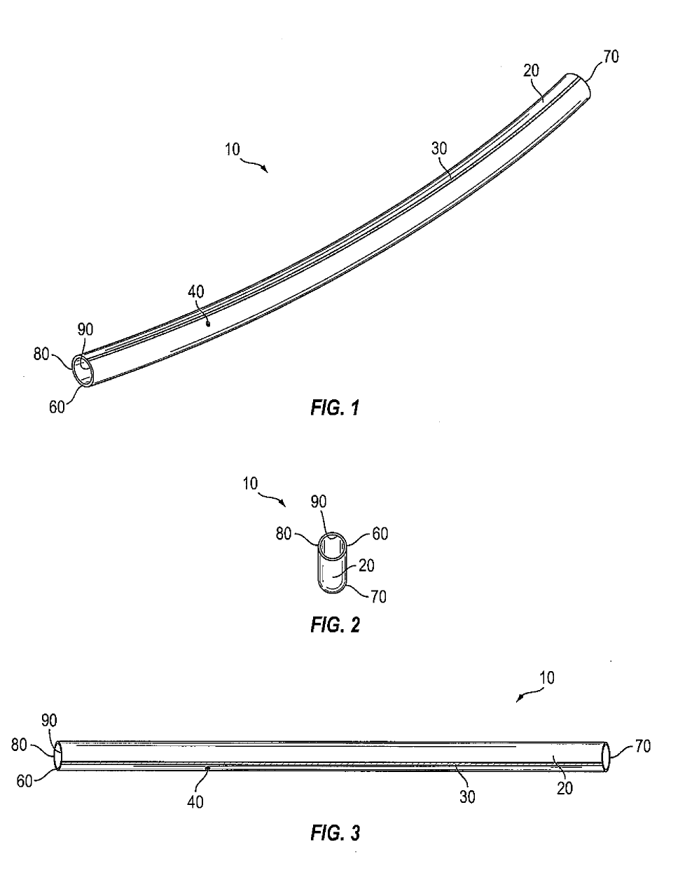

FIGS. 1, 2, and 3 show a section of a pipe 10 according to an embodiment of the present disclosure, wherein FIG. 1 is a perspective view of the pipe, FIG. 2 is a front view of the pipe, and FIG. 3 is a top view of the pipe.

Referring to FIGS. 1, 2, and 3, the pipe 10 of the present embodiment comprises a cylindrical wall 20. The wall 20 may be rigid, or substantially non-compressible, to ensure that material (e.g., liquid) may travel through the pipe 10 after the pipe 10 is buried underground and/or after equipment is placed over the pipe 10. The pipe may be any thermoplastic materials such as polyvinyl chloride, high density polyethylene, linear low density polyethylene, polypropylene, and combinations thereof. Accordingly, the pipe 10 may be used as a dripline (e.g., for subsurface drip irrigation).

The wall 20 may be of polyolefin or any other suitable material. The wall 20 may include a plurality of layers. In some embodiments, the wall 20 may include a polyethylene outer layer 80 and/or a polyethylene inner layer 90. The polyethylene outer layer 80 may be the outer most layer of the wall 20. The polyethylene inner layer 90 may be the innermost layer of the wall 20.

The pipe 10 may further comprise a plurality of openings 40. Because the pipe 10 may be used as a dripline, the pipe may be connected at one end 60 to a reservoir source, such as a water spigot, and may be sealed at the other end 70. The pipe 10 may be connected to other pipes using various splitters to form a network of underground pipes. The plurality of openings 40 may allow material that is delivered through the pipe 10, such as water, herbicide, and/or fertilizer, to exit through the openings 40 into the environment surrounding the pipe 10 (e.g., near the root structure of plants, trees, cacti, etc.). In some embodiments, the openings 40 have a diameter ranging from about two to about three millimeters, although the present embodiment is not limited thereto. It should be noted that the pipe of other embodiments may be used for purposes other than a dripline. For example, the pipe may be used in municipal systems, or may be used for other large scale fluid movement.

The wall 20 may include a filler (e.g., an electrically conductive filler, or a magnetic filler) 30 that extends along the length of the pipe 10 at one side thereof. The filler 30 may be a continuous strip, a continuous stripe, and/or may include discontinuous sections. In some embodiments, when the filler 30 is magnetic, such discontinuous sections of the filler 30 may each be about 0.2 inches in length along the length of the pipe 10 and the discontinuous sections may be separated by a distance of about 0.2 inches along the length of the pipe 10. In other embodiments, when the filler 30 is magnetic, the discontinuous sections of the filler 30 may each be about one inch in length along the length of the pipe 10, about 0.1 inches wide, and may be separated by a distance of up to twelve inches along the length of the pipe 10. In some embodiments, the filler 30 may be located within the wall 20. Alternatively, the filler 30 may be on the inner layer 90 of the wall 20, may be on the outer layer 80 of the wall 20, or may run the length of the pipe 10 between the inner and outer surfaces of the wall 20. In the present embodiment, the filler 30 is on the outer layer 80 of the wall 20.

The filler 30 may be located using electric, electromagnetic, and/or radar signals (e.g., ground-penetrating radar signals). The filler 30 may be of carbon-based material, such as high structure carbon black material (e.g., graphite, graphene, and/or carbon nanomaterial), and/or a magnetic material, such as a form of iron (e.g., iron oxide (e.g., Fe₃O₄), magnetite (e.g. Fe₂⁺Fe₃⁺2O₄), etc.). In some embodiments, the filler 30 may be of electrically conductive ink printed onto the pipe 10, or may be of electrically conductive ink printed onto a carrier strip that may be added to (e.g., laminated onto) the pipe 10 with the conductive ink between the pipe 10 and the carrier strip. The electrical conductivity of the filler 30 enables the pipe 10 to be located or tracked by tracking equipment, as will be described below.

In the present embodiment, the pipe 10 includes a single stripe of the filler 30 at one side thereof. However, in other embodiments, the pipe 10 may include two or more stripes of the filler 30 at respective regions of the pipe 10 (e.g., two stripes of the filler 30 at opposite sides of the pipe 10). Further, in various embodiments, the filler of the two or more stripes may be made of different respective materials, and/or may have different respective properties (e.g., may be differently magnetically charged, may have different thicknesses, or may have different rates of electrical conductivity).

In some embodiments, the filler 30 may be at least partially insulated from the environment by a non-conductive layer, such as the polyethylene outer layer 80, the polyethylene inner layer 90, or some other layer of plastic. Such insulation may prevent electrical charge from dissipating from the filler 30 into the surrounding environment (e.g., directly into the ground contacting the pipe 10), thereby improving the locatability of the pipe 10 by use of radar or other electromagnetic signals. The filler 30 may be insulated by a layer that covers a portion of the pipe 10 without covering the entire pipe 10.

In some embodiments, the filler 30 may be covered by a layer that is reflective to radio waves. In other embodiments, the filler 30 may be, itself, reflective of radio waves. This may enable the pipe 10 to be located using electric, electromagnetic, and/or radar signals (e.g., ground-penetrating radar signals).

The pipe 10 may be placed underground by being placed in a trench and then covered. After being buried, the filler 30 may be up to 24 inches underground in wet, but not saturated, soil or much deeper in dry soil. It should be noted that, although plant roots may interfere with other methods of pipe location that utilize radar, roots will not interfere with the methods of electromagnetic or magnetic detection according to embodiments of the present disclosure. The pipe 10 may be covered by soil, plants/foliage (including roots when the pipe 10 is detected using electromagnetic and/or magnetic signals), and/or other items, such as a polyethylene or polypropylene cover. The pipe 10 (e.g., the filler 30) may receive and emit or reflect a signal detectable by a sensor, which may be used to generate an estimated location of the pipe 10.

For example, a transmitter may emit a signal (e.g., an electromagnetic signal or a radar signal) in proximity to a portion of the pipe 10. The filler 30 at the portion of the pipe 10 may receive the signal from the transmitter. Due to the conductive properties of the filler 30, the filler 30 may transmit the signal therethrough along the length of the pipe 10 to another region of filler 30/the pipe 10. This signal may then be transmitted to a sensor in proximity to the other region of the pipe 10, thereby enabling tracking and location of the pipe 10. The signal generated by the transmitter and conducted through the filler 30 may allow for accurate estimations such that the estimated location detected by the sensor may be within one inch of an actual location of the pipe 10. The strength of the signal emitted by the filler 30 may vary as a function of distance from the transmitter to the region of the filler 30 closest to the transmitter.

The transmitter and the sensor may be part of a single piece of equipment (e.g., may be included in farming equipment), or may be separate devices (e.g., individually hand operated). In some embodiments, the sensor may be a magnetic sensor (e.g., a magnetometer) and/or an antenna on a ground-penetrating radar (GPR) system. The GPR system may also include the transmitter, which may emit radio waves between about 10 MHz and about 2.6 GHz. Such radio waves may be directed to the ground in the general region where the pipe 10 is expected to be located. The radio waves may then be refracted, reflected, and/or scattered by the filler 30 when the radio waves reach the pipe 10. By changing the electromagnetic energy of the radio wave, the filler 30 may provide (i.e., emit or reflect) the signal from the transmitter, which may then be detected by the sensor (e.g., the antenna).

Accordingly, by detecting signals along the length of the pipe 10, the pipe 10 may be located, and damage to the pipe 10 otherwise caused by other equipment (for both activities that dig into soil, and activities occurring on and/or above the soil, such as pruning, fertilizing, spraying, etc.) may be avoided, despite the underground location of the pipe 10. For example, farming activities, such as harvesting, digging, planting, replanting, plowing, pruning, fertilizing, and spraying, as well as activities such as landscaping (e.g., the aeration of golf course fairways and putting greens, where holes may be drilled near driplines), may be performed without damaging the pipe 10 by first detecting the signals emitted by the pipe 10 to avoid performing the activities that may potentially damage the pipe 10 near regions where the pipe is located. Further, the pipe 10 may be located to connect other portions of pipe thereto, or to otherwise perform maintenance on the pipe 10. Accurate estimated locations of the pipe 10 may be used to guide equipment along the length of the pipe 10, and may facilitate the identification of the pipe 10 where roots and/or other objects may be nearby.

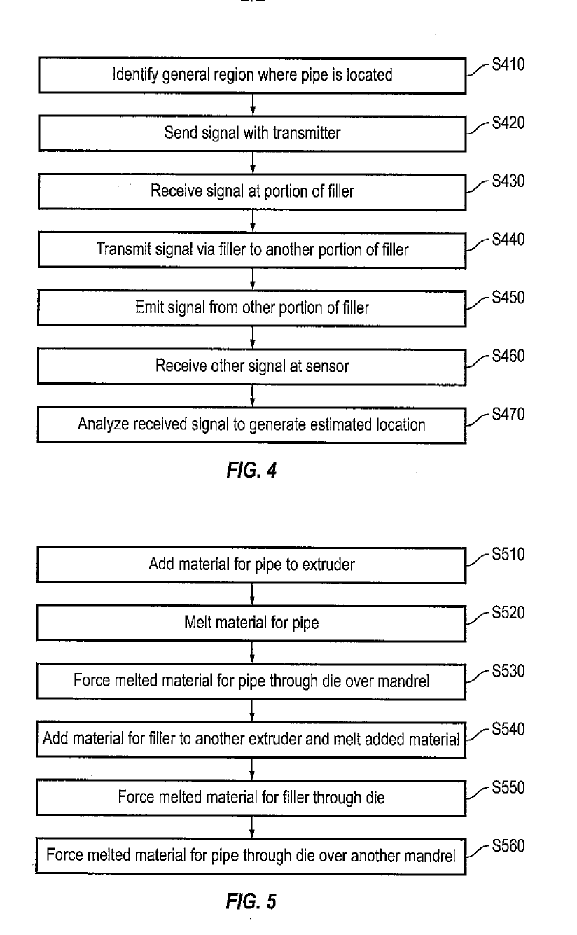

FIG. 4 is a flowchart of a method of locating and tracking a plastic pipe located underground and including a filler (e.g., an electrically conductive filler, or a magnetic filler), according to an embodiment of the present disclosure.

Referring to FIG. 4, at S410, a general region where the pipe is located underground is identified. At S420, a transmitter is used to send a signal toward the general location of the pipe. At S430, the transmitted signal is received by a portion of the filler of the pipe. At S440, the signal received by the portion of the filler is transmitted to another portion of the filler that is electrically connected thereto. At S450, the other portion of the filler emits another signal. The other portion may emit the other signal after the signal is transmitted from the initial portion of the filler to the other portion of the filler.

At S460, the other signal emitted from the other portion of the filler is received by a sensor. At S470, the other signal is analyzed by the sensor to generate an estimated location of the pipe 10. The estimated location may be within one inch of an actual location of the pipe. The estimate location may be generated based on the strength of the other signal relative to the strength of the signal emitted by the transmitter. The estimated location may be outputted onto a map, which may be prepared prior to installation of the pipe 10. Further, a global positioning system (GPS) may be combined with sensors of embodiments of the present disclosure to output a location of a user and/or the estimated location of the pipe 10. S410 through S470 may be repeated at different locations to generate an estimated location for other sections of the pipe and/or to generate an estimated location of another pipe that includes another filler. The other pipe may be included in a network of pipes.

In another embodiment, the pipe 10 of the present embodiment may be formed using an extrusion process. Material for the pipe 10 (e.g., in the form of pellets and/or powder) may be fed to an extruder (e.g., through a hopper to a feed screw), where the material for the pipe is heated and forced through a die that forms the heated material into the cylindrically-shaped pipe 10. A process of coextrusion may be used to form the pipe 10 when the pipe includes multiple layers (e.g., multiple polyolefin layers forming the wall of the pipe). Material for the pipe 10 may be pushed through another die in a multistep process where a mandrel having a different diameter may be used in combination with the other die for each of the multiple layers. Such a process may incorporate the filler 30 into the pipe 10. The plurality of openings 40 may be created after the multiple layers have formed.

FIG. 5 is a flowchart of a method of manufacturing a plastic pipe including a filler (e.g., an electrically conductive filler, or a magnetic filler), according to an embodiment of the present disclosure.

Referring to FIG. 5, at S510, material for the pipe (e.g., plastic pellets and/or powder) may be added to an extruder. At S520, the material may be melted down (e.g., into resin). At S530, the melted material may be forced through a die over a mandrel. At S540, material for the filler may be added to another extruder and may be melted down. At S550, the melted material for the filler may be forced through the die, which may add the filler to the pipe. At S560, the melted material for the pipe may be forced through the die over another mandrel, which may add an outer layer that covers the filler.

As described above, embodiments of the plastic pipe described herein provide an improved plastic pipe suitable for use as a locatable and trackable underground dripline. Embodiments of methods for locating the pipe described herein provide improved location ability, thereby making it easier to avoid unintentionally damaging the plastic pipe when using agricultural/farming equipment nearby. For example, row crops may be planted along the same rows at which a respective dripline is installed.

Accordingly, one could potentially automate the farming of the crop by tracking and following the location of the locatable dripline. Despite the embodiments described above, it should be noted that the pipe may be manufactured by other methods in other embodiments.

The foregoing is illustrative of example embodiments, and is not to be construed as limiting thereof. Although a few example embodiments have been described, those skilled in the art will readily appreciate that many modifications are possible in the example embodiments without materially departing from the novel teachings and advantages of example embodiments. Accordingly, all such modifications are intended to be included within the scope of example embodiments as defined in the claims. In the claims, means-plus-function clauses are intended to cover the structures described herein as performing the recited function and not only structural equivalents but also equivalent structures. Therefore, it is to be understood that the foregoing is illustrative of example embodiments and is not to be construed as limited to the specific embodiments disclosed, and that modifications to the disclosed example embodiments, as well as other example embodiments, are intended to be included within the scope of the appended claims. The inventive concept is defined by the following claims, with equivalents of the claims to be included therein.

What is claimed is:

1. A plastic cylindrical pipe comprising a nonconductive wall, wherein the wall includes a filler that is either electrically conductive or magnetic.

2. The pipe of claim 1, wherein the filler comprises a carbon-based material.

3. The pipe of claim 2, wherein the carbon-based material comprises a high structure carbon black material.

4. The pipe of claim 3, wherein the high structure carbon black material comprises graphite, graphene, or carbon nanomaterial.

5. The pipe of claim 1, wherein the filler is configured to receive and emit a signal detectable by a sensor.

6. The pipe of claim 1, wherein the filler is magnetic and includes discontinuous sections that are about one inch in length and that are separated by about twelve inches.

7. The pipe of claim 6, wherein the filler comprises iron.

8. The pipe of claim 6, wherein the filler comprises iron oxide having the chemical formula of Fe3O4.

9. The pipe of claim 1, further comprising a coating covering the filler, the coating being reflective to radio waves.

10. The pipe of claim 1, wherein the filler is reflective of radio waves.

11. The pipe of claim 1, wherein the filler is arranged along a length of the pipe.

12. The pipe of claim 11, wherein the filler comprises a stripe extending along the length of the pipe.

13. The pipe of claim 11, wherein the filler comprises a plurality of separate stripes at different sides on an outside of the wall of the pipe and extending along the length of the pipe.

14. The pipe of claim 1, wherein the pipe comprises a subsurface drip irrigation tube.

15. The pipe of claim 1, wherein the wall defines a plurality of openings.

16. A method of forming a plastic cylindrical pipe comprising a nonconductive wall, wherein the wall includes a filler that is either electrically conductive or magnetic, the method comprising:
adding material for the pipe to an extruder;
melting the material for the pipe;
pushing the melted material for the pipe through a die over a mandrel;
adding material for the filler into another extruder;
melting the added material for the filler; and
pushing the melted material for the filler through the die.

17. The method of claim 16, wherein the filler comprises a stripe extending along a length of the pipe, the method further comprising:
adding the melted added material for the filler to the melted material for the pipe prior to cooling the melted material for the pipe.

18. A method of locating a plastic cylindrical pipe comprising a nonconductive wall, wherein the wall includes a filler that is either electrically conductive or magnetic, the method comprising:
receiving, by a portion of the filler, a signal emitted from a transmitter;
transmitting, by the portion of the filler, the signal to another portion of the filler;
emitting, by the other portion of the filler, another signal;
detecting the signal using a sensor; and
estimating a location of the plastic cylindrical pipe based on the detected signal.

19. The method of claim 18, wherein the sensor comprises a ground-penetrating radar system.

20. The method of claim 18, wherein the sensor is mounted on a piece of farming equipment or landscaping equipment.
